(19) United States
(12) Patent Application Publication
(10) Pub. No.: US 2015/0331081 A1
(43) Pub. Date: Nov. 19, 2015

(54) AN APPARATUS AND METHOD TO PROVIDE A USER WITH AN INDICATION OF A DIRECTION TO A PARTICULAR DESTINATION

(71) Applicant: NOKIA CORPORATION, Espoo (FI)

(72) Inventors: Alistair WHARTON, Godalming Surrey (GB); Lee MURRAY, London (GB); Vladimir KHOKHLOV, Essex (GB)

(73) Assignee: Nokia Corporation, ESPOO (FI)

(21) Appl. No.: 14/648,213

(22) PCT Filed: Dec. 7, 2012
(86) PCT No.: PCT/IB2012/057077

§ 371 Date: May 28, 2015

(51) Int. Cl. G01S 3/04; G01C 21/26; G01S 3/14

(52) U.S. Cl. CPC G01S 3/046; G01S 3/14; G01C 21/26

(57) ABSTRACT

An apparatus configured to receive, from a remote apparatus (master navigator), a bearing signal indicating the directional offset of a destination with respect to a directional reference, and use the bearing signal to indicate, on a portable apparatus (direction resolver), the heading of the destination with respect to a directional reference of the portable apparatus. Also discussed are a method, computer program code, and a bearing signal.

### TECHNICAL FIELD

The present disclosure relates to the field of navigation, associated methods, computer programs and apparatus. Certain disclosed aspects relate to portable electronic devices, in particular, so-called hand-portable electronic devices which may be hand-held in use (although they may be placed in a cradle in use). Such hand-portable electronic devices include so-called Personal Digital Assistants (PDAs) and tablet personal computers.

The portable electronic devices/apparatus according to one or more disclosed aspects may provide one or more audio/text/video communication functions (e.g. tele-communication, video-communication, and/or text transmission (Short Message Service (SMS)/Multimedia Message Service (MMS)/e-mailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

An electronic device may be able to provide a user with an indication of which direction to travel in to arrive at a particular destination. Such electronic devices include devices with global positioning system (GPS) functionality such as navigators and some mobile telephones and portable computers.

The listing or discussion of a prior-published document or any background in this specification should not necessarily be taken as an acknowledgement that the document or background is part of the state of the art or is common general knowledge.

### SUMMARY

In a first aspect, there is provided an apparatus, the apparatus configured to:
receive, from a remote apparatus, a bearing signal indicating the directional offset of a destination with respect to a directional reference; and
use the bearing signal to indicate, on a portable apparatus, the heading of the destination with respect to a directional reference of the portable apparatus.

A user may plot a route or input a desired destination to a GPS enabled smartphone (an example of a master navigator/remote apparatus). The user may have a portable apparatus/direction resolver to hand. The direction resolver may be a relatively simple device configured to receive a bearing signal and indicate a direction/heading, but need not have GPS or navigating functionality by itself. The apparatus (which may be comprised in the direction resolver or may be the direction resolver itself in certain examples) is configured to receive a bearing signal indicating the directional offset of a destination with respect to a directional reference of the remote apparatus/smartphone. The bearing signal may be, for example, “travel 120° from North”, where 120° is the directional offset from North and North is the directional reference of the remote apparatus/smartphone. Therefore the bearing signal provides an angle away from a known reference as a heading towards a destination.

In the following description, the portable apparatus may be considered a direction resolver and may be configured to indicate a direction of travel to a user. The remote apparatus may be considered a master navigator (for example, it may be a GPS enabled smartphone or navigation device). The apparatus may be the direction resolver or may be comprised in the direction resolver.

The apparatus is also configured to use the bearing signal to indicate, on the direction resolver (portable apparatus), the heading of the destination with respect to a directional reference of the portable apparatus/direction resolver. If the directional reference of the master navigator (remote apparatus) and the portable apparatus/direction resolver are the same, or the relationship between these references is known, it is possible to use the simple bearing signal to navigate. For example, the portable device may be able to determine North (or another known reference direction) itself. The bearing signal instructs the portable device to indicate a direction of 120° from North, which can be calculated from the internal direction reference of the portable apparatus/direction resolver, and indicated to a user. The user can then follow the indicated heading of the destination to arrive at their desired destination. Advantageously, by use of the bearing signal, much like a compass, if the user rotates the portable apparatus/direction resolver the indicated heading will remain pointing towards the desired destination. The user need not consult their remote apparatus/master navigator directly but can still see which direction/heading to travel in just by using their portable apparatus/direction resolver.

The bearing signal may be a current bearing signal valid for a time instance, and the apparatus may be configured to:
receive respective current bearing signals indicating the directional offset of the destination with respect to the directional reference at the respective corresponding time instances; and
use the respective current bearing signals to adjust the indicated heading of the destination as the portable apparatus is moved with respect to a directional reference of the portable apparatus.

Thus the apparatus may receive periodic updates of the bearing signal from the remote apparatus/master navigator. The adjustment of the bearing signal in time may take into account the movement of the portable apparatus/direction resolver to correct the indicated direction heading. The remote apparatus/master navigator may, for example, be able to track the current location of the portable apparatus/direction resolver. This may be via both the master navigator and portable apparatus/direction resolver being considered as co-located (for example, both located at the same user or within a Bluetooth operating radius), or via a known relative orientation and position of the portable apparatus/direction resolver with respect to the remote apparatus/master navigator.

The apparatus may be configured to use the respective current bearing signals to adjust the indicated heading of the destination as the portable apparatus/direction resolver is moved by rotation of the portable apparatus/direction resolver with respect to the directional reference of the portable apparatus/direction resolver; and/or translation of the portable apparatus/direction resolver. For example, as the portable apparatus/direction resolver is rotated about a point (such as a user holding the portable apparatus/direction resolver and stretching out his arm, causing rotation about a vertical axis) the indication of the heading of the destination may rotate in the opposite sense to compensate for the apparatus/direction resolver rotation to keep the indicator pointing toward the destination.

The directional offset may be configured to provide a single directional value for the offset of the destination with respect to the directional reference. The directional offset may be configured to provide a single angular directional value for the offset of the destination with respect to the directional reference in one of: degrees, radians, turns, or gradians.

The directional reference used to provide the bearing signal and/or the directional reference of the portable apparatus may be one of: North; South; East; West; and Magnetic North.

The directional reference used to provide the bearing signal and the directional reference of the portable apparatus/direction resolver may be the same, such that the bearing signal is configured to indicate the directional offset of the destination with respect to the directional reference of the portable apparatus/direction resolver. For example, both the remote/master navigator and portable apparatus/direction resolver may use Magnetic North as a directional reference.

The apparatus may be further configured to, when the remote apparatus/master navigator and portable apparatus/direction resolver are within a pre-configured separation of each other: receive, from the remote apparatus/master navigator, a distance signal indicating the distance away of the destination with respect to a determined location of the remote apparatus/master navigator; and use the distance signal to indicate, on the portable apparatus/direction resolver, an approximate distance away of the destination with respect to the portable apparatus/direction resolver based on the distance away of the destination with respect to the remote apparatus/master navigator. Thus the portable apparatus/direction resolver may indicate, for example, the direction in which to travel to reach a destination and the distance which the user must travel to reach the destination.

The portable apparatus/direction resolver may be configured to be one or more of wearable or carried. The portable apparatus/direction resolver may be one or more of a wrist-wearable device, a clip, a handheld device, a pair of glasses, a pair of headphones, or a module for one or more of the same. It may be, for example, worn as a wristwatch, clipped to a sleeve or cuff, or worn around the neck on a lanyard.

The apparatus may be configured to receive the bearing signal wirelessly from the remote apparatus/master navigator. The apparatus may comprise a receiver configured to receive the bearing signal wirelessly via radio-communication. Such communication may be via Bluetooth, Bluetooth Low Energy (BLE/BTLE), near-field communication (NFC), wireless local area network (WLAN) signals directly or via a server, via a messaging service, data download, or other suitable communication method known in the art. The apparatus may be configured to receive the bearing signal from a wired connection to the master navigator (remote apparatus), for example using low voltage USB attached to a suitably configured item of clothing.

The apparatus may be configured to receive and use the bearing signal to indicate the heading using at least one of a memory, a processor, a micro-electro-mechanical system, and a logic gate configuration of the apparatus.

The heading of the destination may be indicated on the portable apparatus/direction resolver by using an audio and/or visual indication of the direction required to reach the destination. The heading of the destination may be indicated using the portable apparatus/direction resolver by one or more of: indicators positioned around a centre of the portable apparatus/direction resolver (such as a line of LEDs); a clock face indicator of the portable apparatus/direction resolver; a pointer of the portable apparatus/direction resolver; a textual display of the portable apparatus/direction resolver (such as a text display screen which may indicate “turn left” or “head north west”, for example); an audio indicator from the portable apparatus/direction resolver (which may provide spoken instructions or may be provide a beep or tone indicating that the portable apparatus/direction resolver is pointing in the direction of the heading or not); adjustment of the volume level of audio indicators provided to respective speakers of a pair of headphones; and a directional haptic/tactile/vibratory indicator from the portable apparatus/direction resolver.

The heading of the destination with respect to a directional reference of the portable apparatus/direction resolver may be indicated as one or more of an indicator showing the direction in a straight line from the portable apparatus/direction resolver to the destination and an indicator showing an immediate direction of travel required to arrive ultimately at the destination taking into account route parameters. The indicator showing the direction in a straight line may provide an “as the crow flies” indication of the overall heading of the destination. The indicator showing an immediate direction of travel may be provided if, for example, the remote apparatus/master navigator has determined a route through an urban landscape and can provide a series of periodically updated road-by-road bearing signals for the user to follow (and thus take account of route parameters).

The apparatus may be the portable apparatus (e.g., a direction resolver) or a module for the same.

The remote apparatus may be one or more of: a global positioning system device, a smartphone with global positioning system functionality, a personal digital assistant with global positioning system functionality, a navigator, a server, or a module for one or more of the same.

The apparatus and/or portable apparatus/direction resolver may not have global positioning (GPS) system functionality.

In another aspect, there is provided a method, the method comprising:
receiving, from a remote apparatus, a bearing signal indicating the directional offset of a destination with respect to a directional reference; and
using the bearing signal to indicate, using a portable apparatus, the heading of the destination with respect to a directional reference of the portable apparatus.

In another aspect there is provided a computer readable medium comprising computer program code stored thereon, the computer readable medium and computer program code being configured to, when run on at least one processor, perform at least the following:
receive, from a remote apparatus, a bearing signal indicating the directional offset of a destination with respect to a directional reference; and
use the bearing signal to indicate, using a portable apparatus, the heading of the destination with respect to a directional reference of the portable apparatus.

The computer program may be stored on a storage media (e.g. on a CD, a DVD, a memory stick or other non-transitory medium). The computer program may be configured to run on a device or apparatus as an application. An application may be run by a device or apparatus via an operating system.

In another aspect there is provided a bearing signal comprising the directional offset of a destination with respect to a directional reference of a remote apparatus, the bearing signal configured for:
transmission from the remote apparatus to an apparatus; and
use by the apparatus to indicate, on a portable apparatus, the heading of the destination with respect to a directional reference of the portable apparatus.

In another aspect, there is provided an apparatus, the apparatus comprising:
means for receiving, from a remote apparatus, a bearing signal indicating the directional offset of a destination with respect to a directional reference; and
means for using the bearing signal to indicate, using a portable apparatus, the heading of the destination with respect to a directional reference of the portable apparatus.

The present disclosure includes one or more corresponding aspects, examples or features in isolation or in various combinations whether or not specifically stated (including claimed) in that combination or in isolation. Corresponding means and corresponding functional units (e.g. a bearing signal receiver, a heading indicator, a heading calculator, a directional reference determiner, a master navigator, and a direction resolver) for performing one or more of the discussed functions are also within the present disclosure.

Corresponding computer programs for implementing one or more of the methods disclosed are also within the present disclosure and encompassed by one or more of the described examples.

### BRIEF DESCRIPTION OF THE FIGURES

A description is now given, by way of example only, with reference to the accompanying drawings, in which:

FIGS. 1-4 illustrate example apparatus according to the present disclosure;

FIG. 5 illustrates a direction resolver in communication with a master navigator;

FIGS. 6a-6b each illustrate a remote apparatus/master navigator and a portable apparatus/direction resolver, the portable apparatus/direction resolver indicating a heading;

FIGS. 7a-7d illustrate a remote apparatus/master navigator and a user with a portable apparatus/direction resolver, the portable apparatus/direction resolver indicating a heading;

FIGS. 8a-8b illustrate a portable apparatus/direction resolver indicating an approximate distance away to a destination;

FIGS. 9a-9c illustrate indicators on a portable apparatus/direction resolver showing the heading in a straight line to a destination, and an immediate heading of travel required to ultimately arrive at a destination.

FIGS. 10a-10b illustrate an adjustment of the volume level of an audio indicator of a heading of a destination;

FIGS. 11a-11b illustrate an apparatus/direction resolver in communication with a remote server or cloud and a master navigator;

FIG. 12 illustrates a method according to the present disclosure; and

FIG. 13 illustrates schematically a computer readable medium providing a program.

### DESCRIPTION OF EXAMPLE ASPECTS

An electronic device may be able to provide a user with an indication of which direction to travel in to arrive at a particular destination. Such electronic devices include devices with global positioning system (GPS) functionality and devices with mapping functionality, such as navigators and some mobile telephones and portable computers.

For example, a user may be able to input a desired destination to a device with GPS functionality. Using GPS, the device may be able to determine the current location of the user, and plot the user's current location on a map. The device may also be able to provide the user with, for example, a route marked out on the map and/or set of directions to follow in order to arrive at the desired destination. The user may be presented with an arrow or other pointer showing in which direction they should travel.

Such a device may not be practical for use in all situations. For example, if the user is walking and it is raining outside, the device is likely to get wet and may be damaged or difficult to see clearly. Another example is of a user travelling by bicycle. Such a user could not hold a GPS device and also control the bicycle whilst riding. As another example, if a user is walking in an unfamiliar town or city, they may not wish to have their GPS device on show as the user may be a target for a thief.

It may therefore be advantageous for a user to be presented on a portable apparatus/direction resolver with a direction in which to travel in order to reach a particular destination without needing to look at or handle their GPS device. It may also be advantageous for the direction to be presented to the user via a portable device which is small, discrete, may be worn if required rather than carried, which provides a simple clear indication of a direction of travel based on the user's requirements to reach a particular destination, and which is relatively simple and cheap to manufacture. Examples described herein may be considered to provide one or more such advantages, particularly if the direction resolver itself does not have GPS functionality.

Examples depicted in the figures have been provided with reference numerals that correspond to similar features of earlier described examples. These numbered features may appear in the figures but may not have been directly referred to within the description of these particular examples. These have still been provided in the figures to aid understanding of the further examples, particularly in relation to the features of similar earlier described examples.

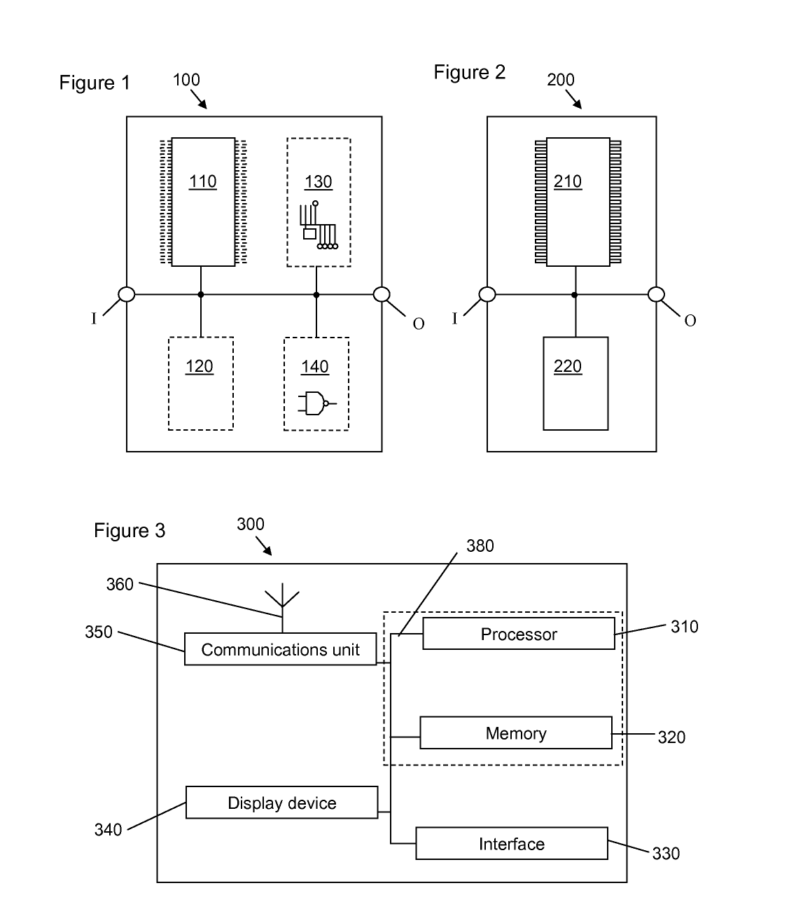

FIGS. 1-4 show apparatus 100, 200, 300, 400 which are configured to receive, from a master navigator (remote apparatus), a bearing signal indicating the directional offset of a destination with respect to a directional reference; and use the bearing signal to indicate, on a direction resolver (portable apparatus), the heading of the destination with respect to a directional reference of the direction resolver.

FIG. 1 illustrates an apparatus which comprises at least one of a processor 110, a memory 120, a micro-electro-mechanical (MEMS) device 130, and a logic gate configuration 140. The apparatus 100 need not contain all these elements. The apparatus also comprises an input I to allow for signalling to be received from further components, and an output O to provide onward signalling to further components.

In particular, in certain embodiments, the apparatus may comprise just one, or more than one, of the elements 110, 120, 130, 140 with respective inputs and outputs configured to perform one or more of the present described methods. In one example, the components of the apparatus I, O, 110, 120, 130, 140 may be integrated in a single chip/circuit for installation in an electronic device, or may be distributed, for example throughout a portable electronic device. The input I may be used to receive the bearing signal from the remote apparatus/master navigator. The output O may be used to provide the heading of the destination for display indication to the user.

A MEMS device 130 may be used as an internal direction reference, as certain MEMS devices may be used to determine the location of North. Such devices are relatively small and may be manufactured on a chip, for example for later integration into a portable apparatus/direction resolver. A logic gate configuration 140 may be used as a calculating device to determine a difference between the internal direction reference of the portable apparatus/direction resolver and the received bearing signal, to output the required heading of the destination. In this sense a logic gate configuration may act as a processing element to process the received bearing signal and calculate a heading for output.

FIG. 2 also illustrates an apparatus 200, which in this example comprises a processor 210, memory 220, input I and output O. Only one processor and one memory are shown but other examples may use more than one processor and/or more than one memory (for example, the same or different processor/memory types). The apparatus 200 may be an application specific integrated circuit (ASIC) for a portable electronic device. The apparatus 200 may also be a module for a device, or may be the device itself, wherein the processor 210 is a general purpose CPU and the memory 220 is general purpose memory.

The input I allows for receipt of signalling (for example, by wired or wireless means or any suitable radio link e.g., Bluetooth or over a WLAN) to the apparatus 200 from further components. The output O allows for onward provision of signalling from the apparatus 200 to further components. In this example the input I and output O are part of a connection bus that allows for connection of the apparatus 200 to further components. The processor 210 is a general purpose processor dedicated to executing/processing information received via the input I in accordance with instructions stored in the form of computer program code on the memory 220. The output signalling generated by such operations from the processor 210 is provided onwards to further components via the output O.

The memory 220 (not necessarily a single memory unit) is a computer readable medium (such as solid state memory, a hard drive, ROM, RAM, Flash or other memory) that stores computer program code. This computer program code stores instructions that are executable by the processor 210, when the program code is run on the processor 210. The internal connections between the memory 220 and the processor 210 can be understood to provide active coupling between the processor 210 and the memory 220 to allow the processor 210 to access the computer program code stored on the memory 220.

In this example the input I, output O, processor 210 and memory 220 are electrically connected internally to allow for communication between the respective components I, O, 210, 220, which in this example are located proximate to one another as an ASIC. In this way the components I, O, 210, 220 may be integrated in a single chip/circuit for installation in an electronic device. In other examples one or more or all of the components may be located separately, for example throughout a portable electronic device, or through a “cloud”, and/or may provide/support other functionality.

The apparatus 200 may be used as a component for another apparatus as shown in FIG. 3. FIG. 3 shows a variation of apparatus 200 incorporating the functionality of apparatus 200 over separate components. In other examples the device 300 may comprise apparatus 300 as a module (shown by the optional dashed line box) for a mobile phone, PDA or audio/video player or the like. Such a module, apparatus or device may just comprise a suitably configured memory and processor.

The example apparatus/device 300 comprises a display 340 such as a Liquid Crystal Display (LCD), e-Ink, or (capacitive) touch-screen user interface. The device 300 is configured such that it may receive, include, and/or otherwise access data. For example, device 300 comprises a communications unit 350 (such as a receiver, transmitter, and/or transceiver), in communication with an antenna 360 for connection to a wireless network and/or a port (not shown). Device 300 comprises a memory 320 for storing data, which may be received via antenna 360 or user interface 330. The processor 310 may receive data from the user interface 330, from the memory 320, or from the communication unit 350. The user interface 330 may comprise one or more input units, such as, for example, a physical and/or virtual button, a touch-sensitive panel, a capacitive touch-sensitive panel, and/or one or more sensors such as infra-red sensors or surface acoustic wave sensors. Data may be output to a user of device 300 via the display device 340, and/or any other output devices provided with apparatus. The processor 310 may also store the data for later user in the memory 320. The device contains components connected via communications bus 380.

The communications unit 350 can be, for example, a receiver, transmitter, and/or transceiver, that is in communication with an antenna 360 for connecting to a wireless network (for example, to transmit a determined geographical location) and/or a port (not shown) for accepting a physical connection to a network, such that data may be received (for example, from a white space access server) via one or more types of network. The communications (or data) bus 380 may provide active coupling between the processor 310 and the memory (or storage medium) 320 to allow the processor 310 to access the computer program code stored on the memory 320.

The memory 320 comprises computer program code in the same way as the memory 220 of apparatus 200, but may also comprise other data. The processor 310 may receive data from the user interface 330, from the memory 320, or from the communication unit 350. Regardless of the origin of the data, these data may be outputted to a user of device 300 via the display device 340, and/or any other output devices provided with apparatus. The processor 310 may also store the data for later user in the memory 320.

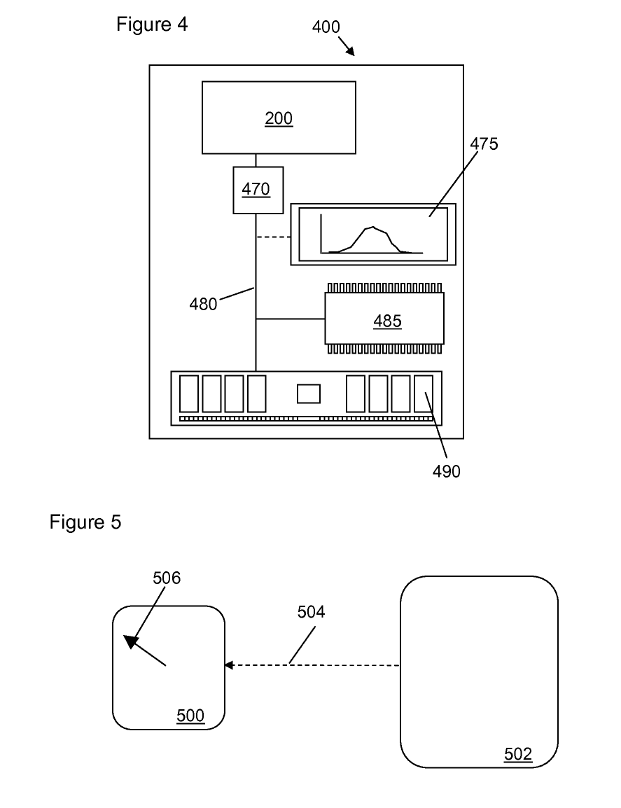

FIG. 4 shows a device/apparatus 400 which may be an electronic device, a portable electronic device, a portable telecommunications device, or a module for such a device (such as a mobile telephone, smartphone, PDA or tablet computer). The apparatus 200 may be provided as a module for a device 400, or even as a processor/memory for the device 400 or a processor/memory for a module for such a device 400. The device 400 comprises a processor 485 and a storage medium 490, which are electrically connected by a data bus 480. This data bus 480 can provide an active coupling between the processor 485 and the storage medium 490 to allow the processor 485 to access the computer program code.

The apparatus 200 in FIG. 4 is electrically connected to an input/output interface 470 that receives the output from the apparatus 200 and transmits this to the device 400 via a data bus 480. The interface 470 can be connected via the data bus 480 to a display 475 (touch-sensitive or otherwise) that provides information from the apparatus 200 to a user. Display 475 can be part of the device 400 or can be separate. The device 400 also comprises a processor 485 that is configured for general control of the apparatus 200 as well as the device 400 by providing signalling to, and receiving signalling from, other device components to manage their operation.

The storage medium 490 is configured to store computer code configured to perform, control or enable the operation of the apparatus 200. The storage medium 490 may be configured to store settings for the other device components. The processor 485 may access the storage medium 490 to retrieve the component settings in order to manage the operation of the other device components. The storage medium 490 may be a temporary storage medium such as a volatile random access memory. The storage medium 490 may also be a permanent storage medium such as a hard disk drive, a flash memory, or a non-volatile random access memory. The storage medium 490 could be composed of different combinations of the same or different memory types.

FIG. 5 illustrates a portable apparatus (direction resolver) 500 in one-way communication with a remote apparatus (master navigator) 502. The master navigator 502 is remote in the sense that it is separate/remote from the direction resolver 500. For example, the master navigator 500 may be a smartphone in a user's bag, and the direction resolver 500 may be a direction indicator on a wrist strap. The direction resolver 500 is configured to receive a bearing signal 504 from the master navigator 502 indicating the directional offset of a destination with respect to a directional reference (for example, 68° from North). The direction resolver 500 uses the bearing signal 504 to indicate the heading of the destination (for example, via an arrow 506) with respect to a directional reference of the direction resolver 500 (such as North). The above may be performed by a suitably configured apparatus which in certain examples is part of the direction resolver, and in other examples is the direction resolver.

The direction resolver 500 is a portable apparatus which may be considered a direction indicator, compass device, or a slave device. In certain embodiments the direction resolver would be a simple device which is readily accessible to a user, for example worn on a wrist strap. The master navigator 502 may be considered a master device, or a bearing signal transmitter. The master navigator in certain examples may be a device configured for navigation, such as a navigator or smartphone with GPS functionality.

The system illustrated in FIG. 5 may be suitable if the master navigator 502 is configured to use off line mapping/GPS functionality and the master navigator 502 is GPS enabled. Only one link is need from the master navigator 502 to the direction resolver 500 and the link may be one way to the direction resolver 500. No external server or cloud is required in certain examples such as this. The bearing signal 504 is sent with respect to a reference of the master navigator 502, and the direction resolver 500 resolves the heading for display to a user from its own reference direction and the received bearing signal 504.

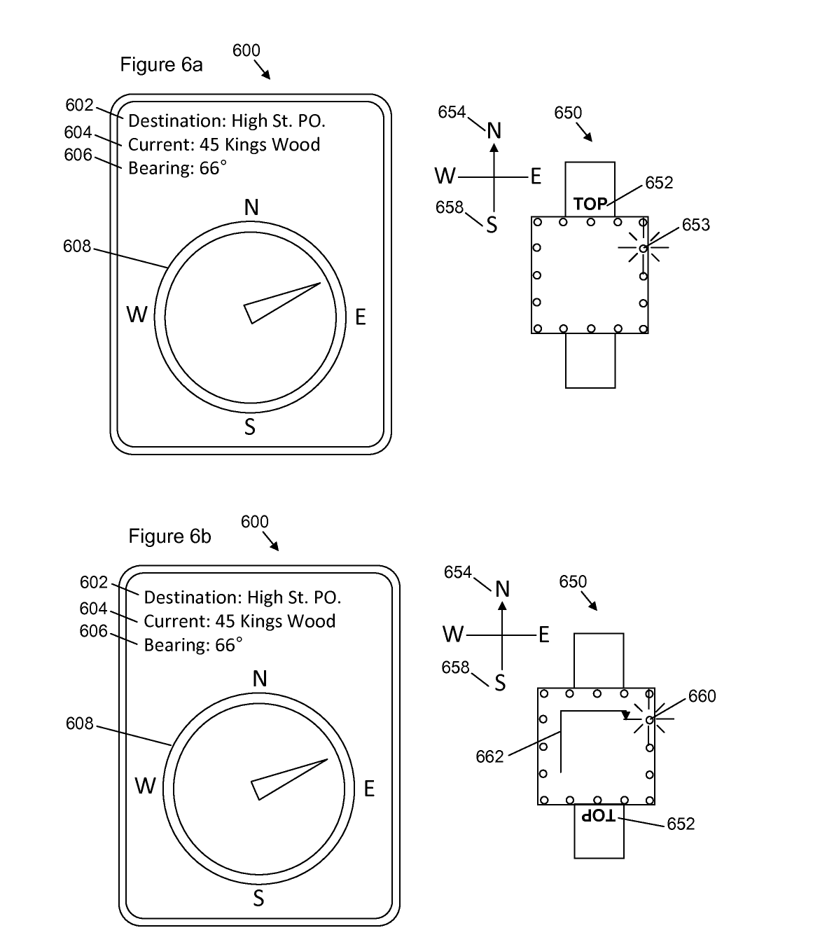

FIGS. 6a and 6b illustrate a direction resolver (portable apparatus) 650 and a master navigator (remote apparatus) 600. In this example, master navigator 600 is a GPS navigation device and direction resolver 650 is a tile on a wrist strap which may be worn similarly to a watch. In some embodiments the apparatus 650 may be a watch which is also configured as described herein to display an indication of a heading of a destination. In FIG. 6a the direction resolver 650 is oriented so that the top of the display 652 is facing North 654, and in FIG. 6b the top of the display 652 is facing South 658.

In this example scenario, a user may wish to use his GPS navigation apparatus 600 to walk to a predetermined destination which he has previously input to the master navigator 600, and master navigator 600 is able to calculate a route for the user to follow from the user's current position to arrive at the predetermined destination. In this example apparatus 600 is displaying the predetermined destination “High Street Post Office” 602, and the user's current location “45 Kings Wood” 604. The apparatus 600 has also determined the current bearing from North which the user must follow to arrive at the predetermined destination. The bearing is shown as “66°” from North 606, and as a pointer indicating 66° from North on a virtual compass 608.

However, in this example, the user does not wish to walk around outdoors holding his GPS navigation apparatus 600 as he travels to his destination. Therefore, rather than looking at the master navigator 600, the user is able to look at his direction resolver 650, and keep his master navigator 600 safely in his pocket or bag. The elements 602, 604, 606, 608 are shown in FIGS. 6a and 6b for illustration, but it will be appreciated that none of these elements need to be displayed if the master navigator device 600 is stored, for example, in the user's bag or pocket. The user need not consult the display of the master navigator device 600 and may use the information displayed on the direction resolver 650 for navigation. The battery of the device 600 may be able to power the master navigator device 600 for longer if few or no elements are displayed on the master navigator device 600.

In this example, the apparatus is the direction resolver 650. In other examples, the apparatus may be a module or component of the direction resolver 650 or may be separate to the direction resolver 650. The direction resolver 650 receives, from the master navigator 600, a bearing signal indicating the directional offset of the destination with respect to the directional reference. In this example the bearing signal corresponds to an angle of 66° 606, 608 away from North (North is the directional reference). Therefore the direction resolver may receive a bearing signal communicating “66° from North”, for example.

The direction resolver 650 then uses the bearing signal to indicate 653 the heading of the destination with respect to the directional reference of the direction resolver 650. In this example, the directional reference (North) used to provide the bearing signal from the master navigator 600, and the directional reference of the direction resolver 650 are the same (the direction resolver 650 also has the directional reference of North). Therefore the bearing signal is configured to indicate the directional offset of the destination with respect to the directional reference of the direction resolver 650. In other examples, the directional reference of the direction resolver 650 and the master navigator 600 need not be the same.

Thus the direction resolver receives a bearing signal of “66° from North”, and, calculating a difference from its own internal directional reference of North, indicates the direction in which the user should travel. In this example, the indicated direction of travel is shown as an illuminated light emitting diode (LED) located towards the outside/perimeter of the direction resolver 650. In this example, only one LED is illuminated, but the heading of the destination may be indicated by two neighbouring illuminated LEDs if in a direction between the two LEDs.

FIG. 6a shows that the master navigator 600 and the direction resolver 650 are both pointing North 654, and so the heading of the destination is shown in the same direction on both apparatus, at 66° from North (towards the top right of the figure). In FIG. 6b, the wearer/user of the direction resolver 650 has turned around by 180° so that the top 652 of their direction resolver 650 is facing South 658. The direction resolver 650 has adjusted the indication of the heading of the destination because the user has moved, so the illuminated LED has moved around 662 the face of the direction resolver 650 as the user moved from facing North 654 to facing South 658. Thus the illuminated LED 660 indicating the heading of the destination is still pointing in the direction in which the user should travel, 66° from North 654.

The directional offset (66°) sent to the direction resolver 650 in this example provides a single directional value in degrees for the offset of the destination with respect to the directional reference (North 654). In other examples, the direction resolver 650 may receive an angular value in radians, turns (e.g., a quarter turn) or gradians, for example.

In this example, the directional reference of the master navigator 600 and of the direction resolver 650 is North 654. In other examples, the directional reference of either apparatus 600, 650, may be North; South; East; West; or Magnetic North, and the directional reference of the master navigator may not be the same as the directional reference of the direction resolver. For example, if the directional reference of the master navigator 600 is North, and the directional reference of the direction resolver 650 is Magnetic North, the bearing signal may be, for example “66° from North”. The direction resolver may use the received information “66° from North”, and also the information “North is x° from Magnetic North”, as well as its own directional reference of Magnetic North, to indicate the heading of the destination with respect to its own directional reference of Magnetic North.

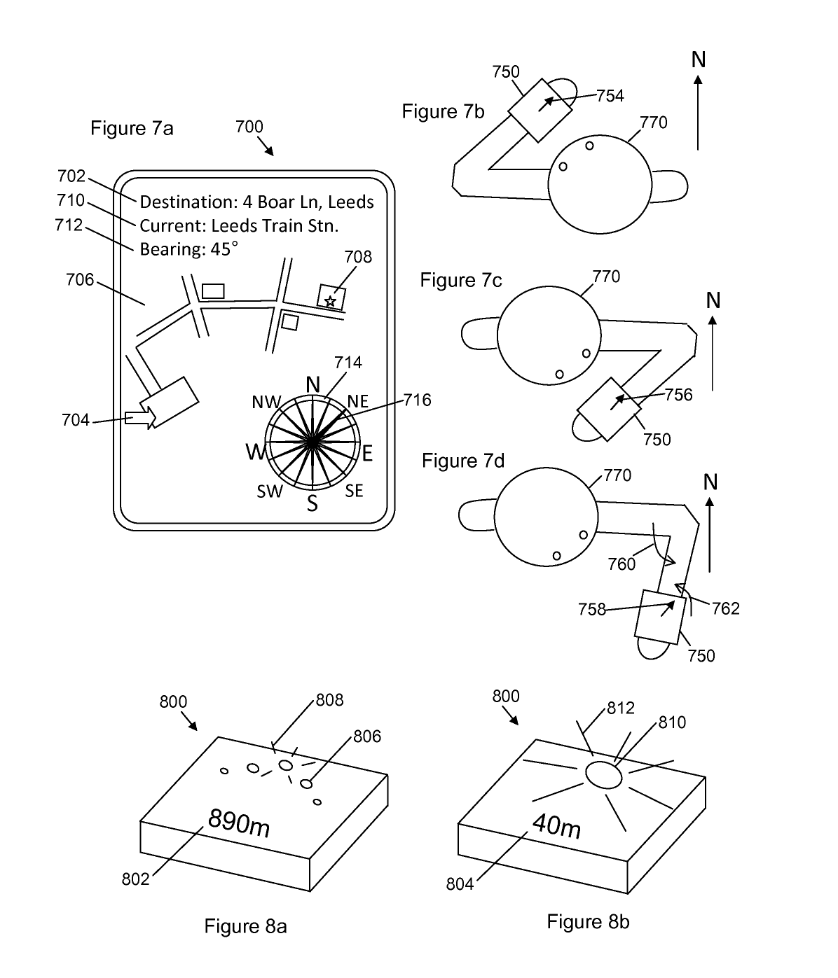

FIG. 7a illustrates a master navigator (remote apparatus) 700, which in this example is a mobile telephone with GPS functionality. A user has entered a desired destination 702 into the master navigator 700. The master navigator 700 has calculated the user's current position 704, and plotted it on a map 706 with the location of the desired destination 708. The desired destination name is displayed 702 as “4 Boar Lane, Leeds” along with the user's current location 710 of “Leeds Train Station” and the bearing 712 of “45°” which the user needs to travel on in order to reach the desired destination 702, 708 from their current location 704, 710. The master navigator 700 also displays a virtual compass 714 indicating the bearing on which the user needs to travel, which is North East 716 (45° from North).

Again, the user does not want to hold their mobile telephone 700 out in public as they walk to their destination. They therefore use a direction resolver (portable apparatus) as shown in FIGS. 7b-7d. The direction resolver 750 in this example is wearable, for example on a wrist strap or a clip attached to the user's cuff or sleeve. In other examples the direction resolver may be carried by the user as a handheld device, or worn as a pair of “augmented reality” glasses provided a “heads-up type display”. None of the displayed elements on the master navigator device 700 need to be displayed if the device 700 is stored in the user's bag or pocket. The user need not consult the display of the device 700 and is able to use the information displayed on the direction resolver 750 for navigation.

In this example both the master navigator 700 and direction resolver 750 have North as a directional reference. The apparatus (which may be the direction resolver 750 or a module for the apparatus 750) receives a bearing signal (such as “45° from North”) from the master navigator 700, indicating the directional offset of the destination with respect to the directional reference (North) of the master navigator 700. The apparatus then uses the bearing signal to indicate on the direction resolver 750 the heading of the destination 702, 708 with respect to a directional reference (also North) of the direction resolver 750.

The user 770 in FIG. 7b is facing North. When the user 770 looks at his direction resolver 750, it indicates using a pointer 754 that he needs to move in a direction which is 45° from North. From his current perspective this is forward and to his right.

In FIG. 7c, the user has turned around to face South. Now when the user 770 looks at his direction resolver 750, the pointer 756 on the direction resolver 750 has rotated to compensate for the user's own rotation which caused a change of angular orientation of the direction resolver 750 with respect to the directional reference of the direction resolver 750. Thus the direction resolver 750 still indicates that the user needs to move in a direction which is 45° from North, but from the user's perspective this is now in a direction behind him and to his left.

In FIG. 7d, the user still faces South, but has swung his arm out 760 to point at a different angle with respect to his body. Now when the user 770 looks at his direction resolver 750, the pointer 758 on the direction resolver 750 has rotated 762 to compensate for the user's arm swing 760, which caused a change of angular orientation of the direction resolver 750 with respect to the directional reference of the direction resolver 750. Thus the direction resolver 750 still indicates that the user needs to move in a direction which is 45° from North 752, but the pointer 758 of the direction resolver 750 has rotated anticlockwise 762 to compensate for the clockwise rotation 760 of the direction resolver itself on the user's arm.

In the examples of FIGS. 6a-6b and 7a-7d, the direction resolver 650, 750 may also be configured to display a distance to destination value (for example on an LCD screen). This distance information may be transmitted from the master navigator 600, 700 to the direction resolver 650, 750 along with the bearing signal.

FIGS. 8a and 8b illustrate an example portable apparatus (direction resolver) 800 which indicates a distance to travel to a destination. In these examples the direction resolver 800 is located close to a master navigator as they are both located with the same user. This separation is considered close enough that the two may be treated as being co-located, such that for the purposes of calculating a distance of a destination away from the master navigator, the distance is approximately the same as the distance from the direction resolver.

In FIG. 8a, the direction resolver 800 indicates in text a distance to travel (890 m) 802. This distance is considered as relatively far away. The heading of the destination is in front of the apparatus 800, and is indicated in this example as a spread of LEDs 806 which are relatively dimly lit 808. The spread of indicators 806 is used to show that the accuracy with which the destination is known is relatively low, due to the relatively long distance between the destination and the direction resolver 800. The spread of illuminated LEDS therefore gives a “fuzzy” indication of the approximate heading. The relatively long distance between destination and direction resolver 800 itself may be indicated by the relatively dim illumination 808.

In FIG. 8b, the direction resolver 800 indicates in text a distance to travel (40 m) 804 which is considered as relatively close to the direction resolver 800. The heading of the destination again is in front of the apparatus 800, and is indicated in this example as a single LED 810 which is relatively brightly lit 812. The single LED indicator 810 is used to show that the accuracy with which the destination is known is relatively high, due to the relatively short distance between the destination and the direction resolver 800. The relatively short distance between destination and direction resolver 800 itself is indicated by the relatively bright illumination 812.

Thus the apparatus is configured to, when the master navigator (remote apparatus) and direction resolver 800 are within a pre-configured separation of each other, receive, from the master navigator, a distance signal indicating the distance away of the destination 802, 804 with respect to a determined location of the master navigator; and use the distance signal to indicate, on the direction resolver 800, an approximate distance away 802, 804 of the destination with respect to the direction resolver 800 based on the distance away of the destination with respect to the master navigator.

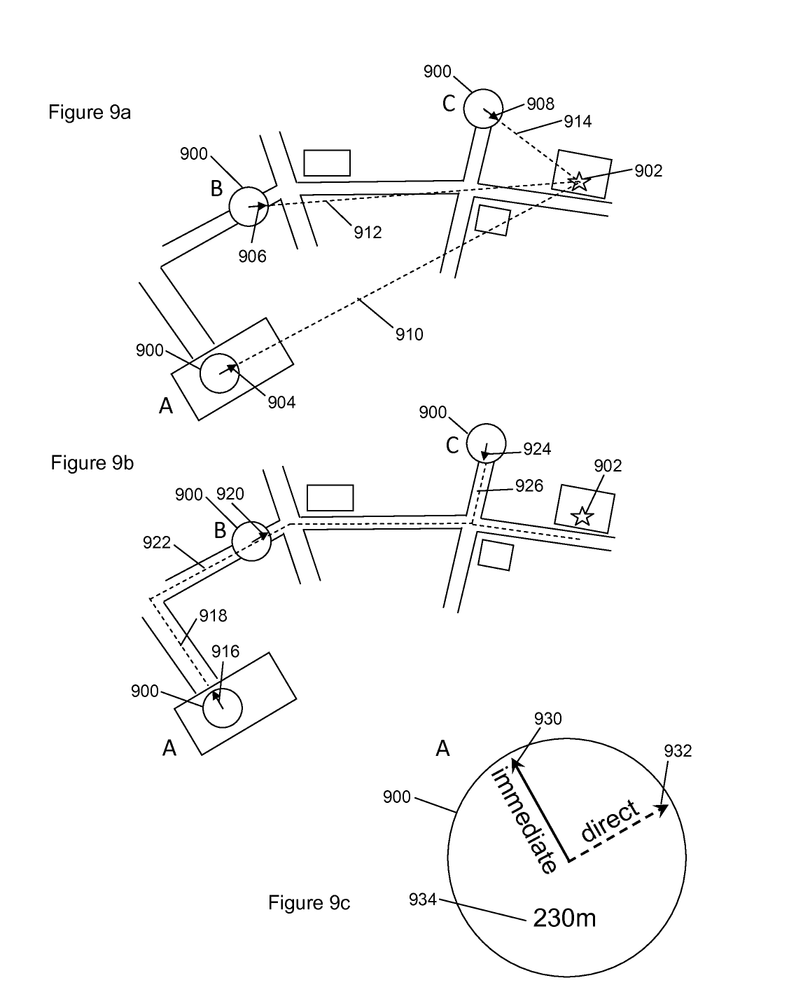

FIGS. 9a-9c illustrate an example in which a portable apparatus (direction resolver) 900 is configured to indicate the heading of the destination 902 with respect to a directional reference of the direction resolver. In FIG. 9a the heading of the destination 902 is given as an indicator showing the direction in a straight line from the direction resolver to the destination. In FIG. 9b the heading of the destination 902 is given by an indicator showing an immediate direction of travel required to arrive ultimately at the destination taking into account route parameters. In FIG. 9c, both indicators are given showing the direction in a straight line from the direction resolver to the destination and an immediate direction of travel required to arrive ultimately at the destination. In some examples a user may be able to configure the settings of the direction resolver himself to decide which indicator is provided or if both are to be provided.

FIG. 9a shows a map indicating a user with a direction resolver 900 at three locations A, B and C along their journey. The user wishes to arrive at a destination 902. The heading of the destination 902 is given as an indicator showing the direction in a straight line from the direction resolver to the destination. Therefore at each location A, B, and C, the direction indicated 904, 906, 908 on the direction resolver 900 corresponds to the direction in a straight line (“as the crow flies”) 910, 912, 914 from the current location of the user (and direction resolver 900) and the destination 902.

FIG. 9b also shows a map indicating a user with a direction resolver 900 at three A, B and C along their journey to their destination 902. The heading of the destination 902 is given by an indicator showing an immediate direction of travel required to arrive ultimately at the destination taking into account route parameters. Such route parameters may include, for example, known roads, footpaths and pedestrianised areas. An immediate direction of travel required may be, for example, along a road on which the user is currently located to arrive at a junction. The immediate direction of travel required may be transmitted from the master navigator (remote apparatus) as a bearing signal based on route calculated using GPS at the master navigator, for example.

Therefore at each location A, B, and C in FIG. 9b, the direction indicated 916, 920, 924 on the direction resolver 900 corresponds to immediate direction of travel required. Thus at location A, the user should travel as indicated by the apparatus' pointer 916 along the road 918; at location B, the user should travel as indicated by the apparatus' pointer 920 along the road 922; and at location C, the user should travel as indicated by the apparatus' pointer 924 along the road 926, in order to arrive at the planned destination 902. In this example, there may be more than one possible immediate direction of travel. Thus a signal may be received from the master navigator which corresponds to a particular one of the plurality of possible immediate directions for travel. The particular one may be selected based on, for example, the shortest overall travel distance, the least currently congested immediate and/or overall travel route, and/or the most appropriate immediate route for the user (for example, if the user has specified that they are travelling by bicycle, the route indicated may preferentially by along a cycle path). Other possible criteria are also known to the skilled person and are included.

FIG. 9c illustrates an example direction resolver indicating both an indicator showing the direction in a straight line from the direction resolver to the destination 932 and an indicator showing an immediate direction of travel required to arrive ultimately at the destination 930. The distance 934 from the current location of the direction resolver 900 to the destination is also indicated in this example. This distance may be in a straight line to the destination or along a particular route to the destination. In other examples, both such distances may be indicated.

Generally in FIGS. 9a-9b, the apparatus receives a current bearing signal valid for a particular time instance. The apparatus is configured to receive respective current bearing signals indicating the directional offset of the destination with respect to the directional reference at the respective corresponding time instances. This regular updating of the bearing signal is required because the user is changing their current position (and that of the direction resolver) as they walk towards their destination. The bearing signal is updated in time (for example, in real time, periodically, or upon a change in direction and/or location being detected). The apparatus is configured to use the respective current bearing signals to adjust the indicated heading of the destination as the direction resolver is moved with respect to a directional reference of the direction resolver.

Therefore as the direction resolver (and the user) move, the bearing signal is updated and timely relevant direction information is conveyed to the user. To do this, the master navigator needs to know the current location of the direction resolver. This may be achieved by the remote and direction resolver being essentially co-located (such as both being held or located with the same user) so that when the master navigator obtains its own location using GPS, this can be treated also as the approximate location of the direction resolver. In other examples, the direction resolver may itself have some GPS functionality so that it may determine its current location (but may not have the functionality to display a map, for example).

As shown in FIGS. 9a-9b, the apparatus is configured to use the respective current bearing signals to adjust the indicated heading of the destination as the direction resolver 900 is moved by rotation and translation of the direction resolver with respect to the directional reference of the direction resolver 900.

In the above examples the user's direction resolver receives a bearing signal from a master navigator which has GPS functionality, and it is using this GPS functionality that the user's route/direction for travel has been determined. Another example which does not rely on GPS is that of a user wishing to locate a particular shop in a large shopping centre. A user may be able to find the particular shop in an interactive directory and transfer the heading of the shop to his direction resolver. For example, a user may be able to obtain information using his direction resolver from an interactive directory information point in the shopping centre. Through near field communication (NFC), for example, a bearing signal indicating the directional offset of the shop of interest, from the information point location, may be transferred to the portable, so that the direction resolver can indicate the heading of the shop to the user. The user can then easily see from the direction resolver, for example, “I need to head forwards and to the right” and move towards the shop of interest. There may be several such information points throughout the shopping centre so that the user can check and re-receive a bearing signal from another information point on their way to the shop if they wish.

Another example relates to finding a particular Bluetooth tag, for example in a warehouse of tagged items. A master navigator such as a mobile telephone or Bluetooth tag reader may be used to determine the position of the particular tag of interest using a Bluetooth antenna or antennae. A difference between the determined position and an internal direction determiner of the master navigator may be calculated to obtain the bearing signal. The internal direction determiner of the master navigator may be a magnetometer, gyroscope, or other means as known in the art. The bearing signal may then be transmitted form the master navigator to the direction resolver which can indicate the location of the Bluetooth tag of interest to the user. This may be convenient for a warehouse worker, for example, who may need their hands free for carrying goods and therefore may not wish to carry the master navigator in their hands. The master navigator may remain in their pocket, and the direction resolver may be worn on a wrist strap, for example.

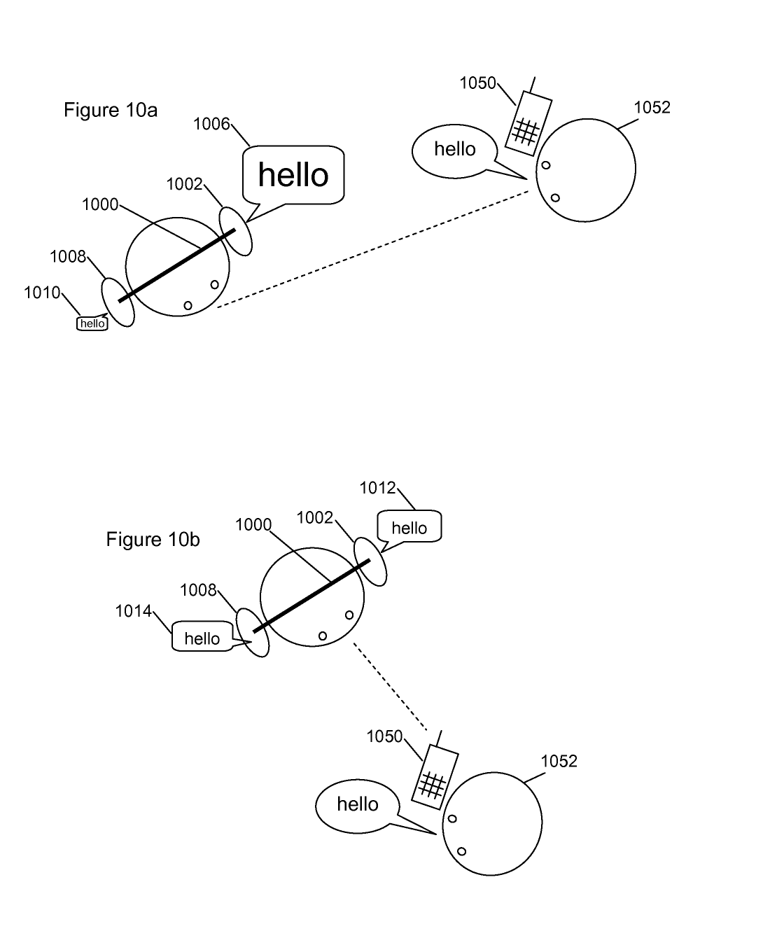

FIG. 10 illustrates an example wherein the direction resolver (portable apparatus) is a pair of headphones 1000 worn by the user 1002, and the master navigator (remote apparatus) 1050 is a mobile telephone of a contact 1052 with whom the user 1002 is currently holding a telephone call. The user 1002 wants to meet up with the contact 1052 but the meeting place chosen is very busy (not shown in the figures) and it is difficult for the two people 1002, 1052 to see each other in the crowds.

An apparatus (which may be comprised in the user's headphones, for example), is configured to receive, from the contact's mobile telephone 1050, a bearing signal indicating the directional offset of the location of the contact 1052 with respect to a directional reference, such as North. The location of the contact 1052 may be considered to be the destination, and the direction from the user 1002 to the contact 1052 may be considered to be the heading of the destination.

The apparatus then uses the bearing signal to indicate, by the user's headphones 1000, the heading of the location of the contact 1052 with respect to a directional reference of the headphones (for example, the headphones may contain a MEMS device which can determine the position of North). The headphones 1000 can then convey the heading of the contact to the user by adjustment of the volume level of audio indicators provided to respective speakers/earpieces of the pair of headphones 1000.

In FIG. 10a, the contact 1052 is located to the left of the user 1002. The audio indicator in this example is the speech and sound output from the telephone call with the contact 1052. In FIG. 10a, since the contact 1052 is almost immediately to the left of the user 1002, the left headphone speaker 1004 provides a loud audio output 1006 as it is closest to the heading of the contact 1052. The right headphone speaker 1008 provides a very quiet audio output 1010 as it is furthest away from the heading of the contact 1052. The user may then realise he should turn to his left to better face the contact 1052.

In FIG. 10b, the contact 1052 is located in front of the user 1002. Since the contact 1052 is equally to the left and the right of the user, that is they are in front of the user 1002, the left headphone speaker 1004 provides an audio output 1012 of equal volume to the audio output 1014 of the right headphone speaker 1008. The user can then walk forwards and will eventually meet up with the contact 1052. If the contact 1052 was located directly behind the user, the volume of the audio output may be very quiet through both headphone speakers 1002, 1008. If this is the case an additional audio signal may be provided to the user, for example a command to “turn around”, so that the user understands that the overall quiet volume level is related to them facing in the opposite direction to their destination and not related to, for example, a faulty connection or broken headset. In general, rather than the volume of the speech output being varied as the user changes angular orientation, the user may hear a series of tones or beeps which vary in volume as the user rotates.

In this way as shown in FIGS. 10a-10b, an intuitive feedback system may allow the user to turn around to face the contact with whom they are trying to meet up, with the hope that they will be easier to spot in a crowd because the user knows he is at least facing in the right direction.

In the examples above, the bearing signal may be received by the apparatus via wireless radio-communication, such as by Bluetooth or Bluetooth Low Energy (BLE/BTLE). Using a BTLE one way link may be advantageous as pairing is not required (as required, for example, using Bluetooth), and BTLE requires very low power. A BTLE device may be powered, for example, by a button-cell/coin-cell battery. Other wireless radio-communication methods which may be used include near-field communication (NFC), via a wireless local area network (WLAN) connection directly or via a server, via a messaging service, data download, or other suitable communication method known in the art. An example of wired communication is low voltage USB which may be used, for example, if the devices physically connect via an item of clothing or a bag, for example.

Certain examples may provide with user with an audio, a visual, or both an audio and a visual indication of the direction required to reach the destination. For example, a direction resolver may have a visual indicator of a pointer indicating the travel heading required, and if the user is facing the correct direction an audio indicator could also be output so that the user knows they are facing the correct way. A directional haptic indicator may also or alternatively be included so that the apparatus/device vibrates, for example if the direction resolver is rotated away from the required heading.

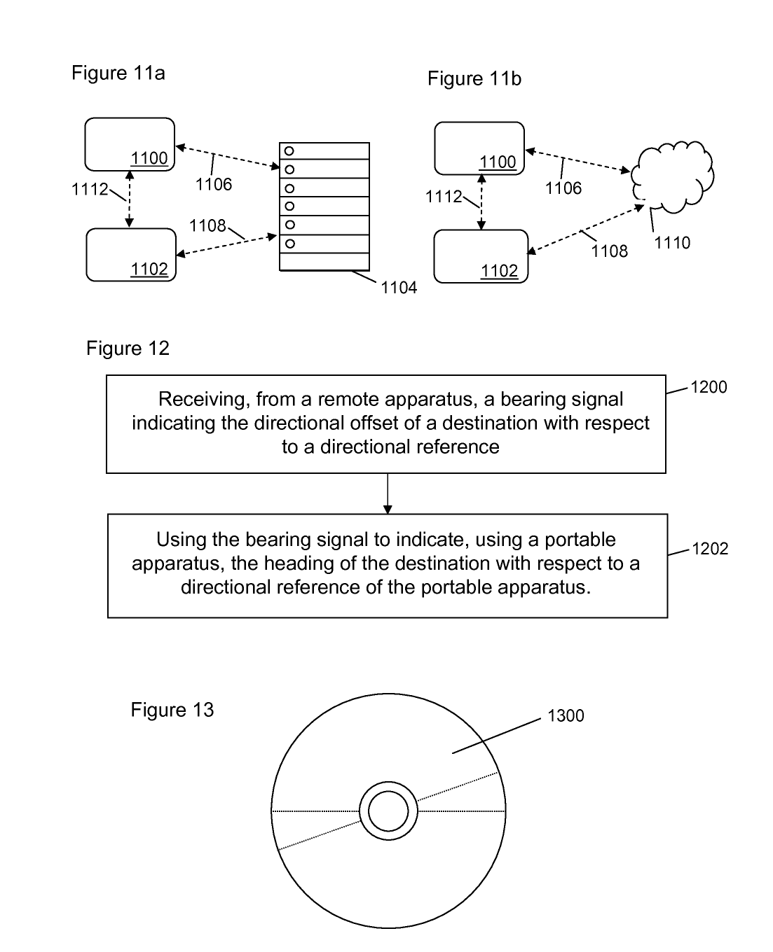

FIGS. 11a and 11b illustrate examples which involve other computing devices. FIG. 11a shows an apparatus 1100 in communication with 1106 a remote server 1104 and in communication with 1112 with a master navigator (remote apparatus) 1102. FIG. 11b shows an apparatus 1100 in communication with 1106 a “cloud” 1110 for cloud computing, and in communication with 1112 with a master navigator 1102. In this example the apparatus 1100 is the direction resolver configured to act as a direction/heading resolver and indicate a heading to a user. In other examples the apparatus 1100 may form part of the direction resolver or may be separate to the direction resolver. The master navigator 1102 (remote with respect to the direction resolver 1100), is shown both in direct 1112 and in indirect 1106, 1108 communication with the direction resolver 1100. The direction resolver 1100 may be an apparatus such as that shown in FIGS. 1-4, for example.

The master navigator 1102 is in direct communication with 1112 the direction resolver 1100 in relation to certain communications/data transfers, and in indirect communication with 1106, 1108 the direction resolver 1100 in relation to other communications/data transfers. Thus, the direction resolver 1100 can communicate with the master navigator 1102 via the remote computing element 1104, 1110 and also directly 1112 with the master navigator 1102. The direction resolver 1100 and/or the master navigator 1102 may be in communication with the remote computing element 1104, 1110 via a communications unit 350, for example.

In certain examples, the master navigator 1102 may only be in indirect communication 1106, 1108 with the direction resolver 1100. In other examples, the master navigator 1102 may only be in direct communication with 1112 the direction resolver 1100.

The direction resolver 1100 may be in wireless communication with the remote computing element 1104, 1110. The master navigator 1102 may be in wired or wireless communication with the remote computing element 1104, 1110 and/or with the direction resolver 1100. Communication may be via the internet, Bluetooth®, a USB connection, or any other suitable connection as known to one skilled in the art. The cloud 1110 in FIG. 11b may be the Internet, or a system of remote computers configured for cloud computing. The direction resolver 1100 is configured to receive a bearing signal indicating the directional offset of a destination with respect to a directional reference from the master navigator 1102 via the server 1104 or cloud 1110, or directly from the master navigator 1102.

A two way link between the direction resolver 1100 and the master navigator 1102 may be advantageous, for example, if switching between “as the crow flies” and “turn-by-turn” navigation modes as discussed in relation to FIGS. 9a-9b. In this example, the direction resolver may comprise a haptic sensor and be configured to switch between modes upon the haptic sensor detecting the direction resolver has been shaken. To indicate which mode is currently in use to the user, an LED heading indicator may flash during “turn-by-turn” navigation and not flash/remain illuminated during “as the crow flies” navigation, for example. The master navigator still only needs to send a bearing signal to the direction resolver, and the direction resolver sends a signal to the master navigation to request a bearing signal in the other mode (as the crow flies mode, or turn-by-turn route mode).

FIG. 12 illustrates a method of receiving, from a remote apparatus, a bearing signal indicating the directional offset of a destination with respect to a directional reference 1200, and using the bearing signal to indicate, using a portable apparatus, the heading of the destination with respect to a directional reference of the portable apparatus 1202.

FIG. 13 illustrates schematically an example comprising a computer/processor readable medium 1300 providing a computer program. In this example, the computer/processor readable media is a disc such as a digital versatile disc (DVD) or a compact disc (CD). In other examples, the computer readable media may be any media that has been programmed in such a way as to carry out an inventive function.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some examples, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such examples can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some examples one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects may consist of any such individual feature or combination of features. In view of the foregoing description it will be evident to a person skilled in the art that various modifications may be made within the scope of the disclosure.

While there have been shown and described and pointed out fundamental novel features of the disclosure as applied to examples thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or example may be incorporated in any other disclosed or described or suggested form or example as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-21. (canceled)

22. An apparatus, the apparatus configured to:
receive, from a remote apparatus, a bearing signal indicating a directional offset of a destination with respect to a directional reference; and
use the bearing signal to indicate, on a portable apparatus, a heading of the destination with respect to a directional reference of the portable apparatus.

23. The apparatus of claim 22, wherein the bearing signal is a current bearing signal valid for a time instance, and the apparatus is configured to:
receive respective current bearing signals indicating the directional offset of the destination with respect to the directional reference at the respective corresponding time instances; and
use the respective current bearing signals to adjust the indicated heading of the destination as the portable apparatus is moved with respect to a directional reference of the portable apparatus.

24. The apparatus of claim 23, wherein the apparatus is configured to use the respective current bearing signals to adjust the indicated heading of the destination as the portable apparatus is moved by:
rotation of the portable apparatus with respect to the directional reference of the portable apparatus; and/or
translation of the portable apparatus.

25. The apparatus of claim 22, wherein the directional offset is configured to provide a single directional value with respect to the directional reference.

26. The apparatus of claim 22, wherein the apparatus is configured to receive the bearing signal wirelessly from the remote apparatus.

27. The apparatus of claim 22, wherein the apparatus comprises a receiver configured to receive the bearing signal wirelessly via radio-communication.

28. The apparatus according to claim 22, wherein the apparatus is configured to receive and use the bearing signal to indicate the heading using at least one of a memory, a processor, a micro-electro-mechanical system, and a logic gate configuration of the apparatus.

29. The apparatus of claim 22, wherein the heading of the destination is indicated on the portable apparatus by using an audio and/or visual indication of a direction required to reach the destination.

30. A computer readable medium comprising computer program code stored thereon, the computer readable medium and computer program code being configured to, when run on at least one processor, perform at least the following:
receive, from a remote apparatus, a bearing signal indicating the directional offset of a destination with respect to a directional reference; and
use the bearing signal to indicate, using a portable apparatus, the heading of the destination with respect to a directional reference of the portable apparatus.

31. A method comprising:
receiving, from a remote apparatus, a bearing signal indicating the directional offset of a destination with respect to a directional reference; and
using the bearing signal to indicate, using a portable apparatus, the heading of the destination with respect to a directional reference of the portable apparatus.

32. A bearing signal comprising the directional offset of a destination with respect to a directional reference of a remote apparatus, the bearing signal configured for:
transmission from the remote apparatus to an apparatus; and
use by the apparatus to indicate, on a portable apparatus, the heading of the destination with respect to a directional reference of the portable apparatus.
